(19) United States
(12) Patent Application Publication
(10) Pub. No.: US 2015/0339060 A1
(43) Pub. Date: Nov. 26, 2015

(54) STORAGE SYSTEM

(71) Applicant: SAMSUNG ELECTRONICS CO., LTD., SUWON-SI (KR)

(72) Inventors: HYUN-JUNG SHIN, YONGIN-SI (KR); JU-PYUNG LEE, SUWON-SI (KR)

(21) Appl. No.: 14/713,013

(22) Filed: May 15, 2015

(30) Foreign Application Priority Data
May 20, 2014 (KR) 10-2014-0060436

(51) Int. Cl. G06F 3/06

(52) U.S. Cl. CPC G06F 3/0608; G06F 3/0641; G06F 3/0619; G06F 3/0673

(57) ABSTRACT

A storage system includes a control unit which receives data from a client, and a storage device which stores the data. The control unit includes a deduplicator which determines whether the data is duplicate or not and generates duplicate information based on the determination result. The storage device includes a mapping table that includes logical block address (LBA)-physical block address (PBA) translation information and the duplicate information.

This application claims priority from Korean Patent Application No. 10-2014-0060436 filed on May 20, 2014 in the Korean Intellectual Property Office, the disclosure of which is incorporated herein by reference in its entirety.

### BACKGROUND

1. Field of the Inventive Step

The present inventive step relates to a storage system.

2. Description of the Related Art

Deduplication is a technique of efficiently managing duplicate data by managing the same data using a link value instead of repeatedly storing the same data. Deduplication can improve storage utilization and reduce the amount of data transmitted over the network. Therefore, deduplication may be needed for a storage system for large-volume data.

The result of deduplication may be recorded in a mapping table. However, if the result of deduplication is managed in a separate mapping table, the size of the mapping table is increased, and may make it difficult to efficiently manage a storage system.

### SUMMARY

Aspects of the present inventive concept provide a storage system which can efficiently manage information about the result of deduplication using a reduced amount of storage thereof by integrating the information into an existing mapping table including logical block address (LBA)-physical block address (PBA) translation information.

However, aspects of the present inventive concept are not restricted to the one set forth herein. The above and other aspects of the present inventive concept will become more apparent to one of ordinary skill in the art to which the present inventive concept pertains by referencing the detailed description of the present inventive concept given below.

According to an aspect of the present inventive concept, there is provided a storage system comprising: a control unit which receives data from a client; and a storage device which stores the data, wherein the control unit comprises a deduplicator which determines whether the data is duplicate or not and generates duplicate information based on the determination result, and the storage device comprises a mapping table which comprises logical block address (LBA)-physical block address (PBA) translation information and the duplicate information.

According to another aspect of the present inventive concept, there is provided a storage system comprising: a storage device which stores first data; and a control unit which determines whether second data received from a client is identical to the first data by comparing the second data with the first data and the second data and generates duplicate information based on the determination result, wherein the storage device comprises a mapping table which comprises LBA-PBA translation information of the first data, LBA-PBA translation information of the second data, and the duplicate information.

### BRIEF DESCRIPTION OF THE DRAWINGS

The above and other aspects and features of the present inventive concept will become more apparent by describing in detail exemplary embodiments thereof with reference to the attached drawings.

FIG. 1 is a schematic block diagram of a storage system according to an embodiment of the present inventive concept.

FIG. 2 is a flowchart illustrating a method of operating the control unit and the storage device.

FIGS. 3 and 4 are diagrams illustrating the method of operating the control unit and the storage device.

FIG. 5 is a schematic block diagram of a storage system according to another embodiment of the present inventive concept.

FIG. 6 is a block diagram of an electronic device including a nonvolatile memory according to an embodiment of the present inventive concept.

FIG. 7 is a block diagram of an electronic device including a nonvolatile memory according to another embodiment of the present inventive concept.

FIG. 8 is a block diagram of an electronic device including a nonvolatile memory according to another embodiment of the present inventive concept.

FIG. 9 is a block diagram of an electronic device including a nonvolatile memory according to another embodiment of the present inventive concept.

FIG. 10 is a block diagram of an electronic device including a nonvolatile memory according to another embodiment of the present inventive concept.

FIG. 11 is a block diagram of an electronic device including a nonvolatile memory according to another embodiment of the present inventive concept.

FIG. 12 is a block diagram of an electronic device including nonvolatile memories according to another embodiment of the present inventive concept.

FIG. 13 is a block diagram of a data storage device including the electronic device of FIG. 12.

### DETAILED DESCRIPTION OF THE EMBODIMENTS

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the present inventive concept will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle may, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

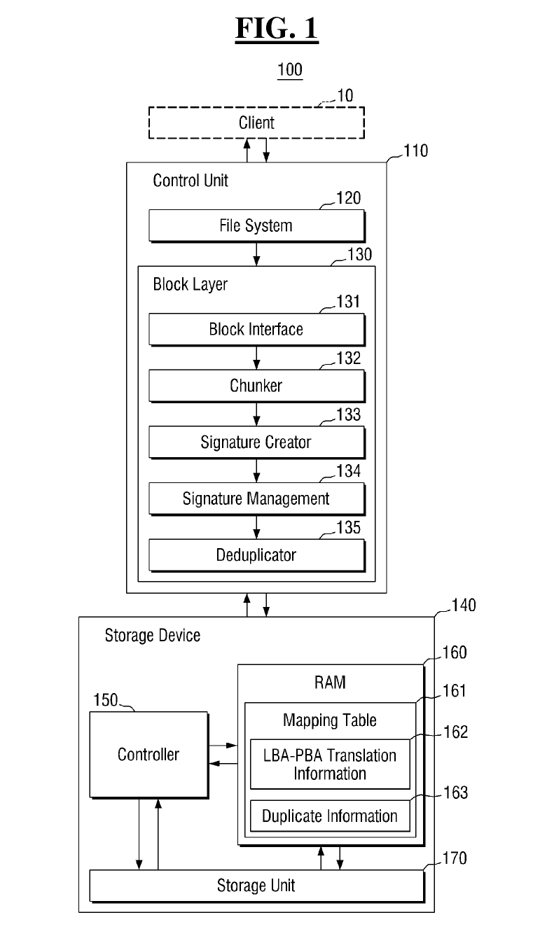

A storage system according to an embodiment of the present inventive concept will now be described with reference to FIG. 1. FIG. 1 is a schematic block diagram of a storage system 100 according to an embodiment of the present inventive concept. Referring to FIG. 1, the storage system 100 includes a control unit 110 and a storage device 140. The control unit 110 may receive a data input or output request from a client 10 and write data to the storage device 140 or read data stored in the storage device 140 in response to the received data input or output request. The control unit 110 may communicate with the storage device 140 using universal serial bus (USB), small computer system interface (SCSI), peripheral component interconnect (PCI) express, advanced technology attachment (ATA), parallel ATA (PATA), serial ATA (SATA), serial attached SCSI (SAS), etc.

The control unit 110 may perform deduplication. Specifically, the control unit 110 may compare data received from the client 10 with data stored in the storage device 140 to determine whether the received data is identical to the stored data and may generate duplicate information indicating whether the received data is identical to the stored data. The generated duplicate information may be transmitted to the storage device 140. The storage device 140 may store the duplicate information and use the duplicate information for data placement such as cache, wear leveling, etc.

Since the control unit 110 performs deduplication, the efficiency of deduplication can be increased, and high-level deduplication such as file-level deduplication, application-level deduplication, etc. can be performed. In addition, the control unit 110 provides the duplicate information to the storage device 140, so that the storage device 130 can utilize the duplicate information for data placement.

The control unit 110 may include a file system 120 and a block layer 130. The block layer 130 may include a block interface 131, a chunker 132, a signature creator 133, a signature management unit 134, and a deduplicator 135. The file system 120 links a logical block address (LBA) to data received from the client 10.

The block layer 130 receives data linked with an LBA from the file system 120 and deduplicates the received data. Specifically, the block interface 131 may receive or transmit data linked with an LBA from or to the file system 120. The block interface 131 may be a data transmission/reception method that supports data input/output. Examples of the data transmission/reception method may include ATA, integrated drive electronics (IDE), SATA, and nonvolatile memory express (NVMe).

In response to a request to store data received from the client 10, the chunker 132 may chunk (split) the data requested to be stored into a plurality of unit blocks of data. For example, the chunker 132 may chunk the data requested to be stored into blocks of a fixed length or blocks of a variable length. If necessary, the chunker 132 may collect data of small sizes and create a large unit block of data. The chunker 132 may chunk the data into blocks of, e.g., 512 bytes or 4 Kbytes.

The signature creator 133 creates a signature for each of unit blocks into which the chunker 132 chunks data. The signature may be, e.g., a hash value. If the signature is a hash value, the signature creator 133 may calculate a hash value of the data requested to be stored by using a hash algorithm or a hash function. For example, the signature creator 133 may calculate the hash value of the data requested to be stored by using GOST, HAVAL, MD2, MD4, MD5, PANAMA, RadioGatun, RIPEMD, RIPEDMD-128/256, RIPEMD-160, RIPEMD-320, SHA-0, SHA-1, SHA-256/224, SHA-512/384, SHA-3, WHIRLPOOL, etc.

Alternatively, the signature creator 133 may calculate a hash value using a similarity-based hash instead of a cryptographic hash. The signature management unit 134 may store signatures created by the signature creator 133 in the form of a signature table. Therefore, the signature management unit 134 may store not only the signature of the data requested to be stored but also signatures of data already stored in the storage device 140.

The deduplicator 135 determines whether data is duplicate or not and generates duplicate information based on the determination result. The deduplicator 135 may compare data requested by the client 10 to be stored with data already stored in the storage device 140 to determine whether the data requested to be stored is identical to the stored data. Alternatively, the deduplicator 135 may determine whether the data requested to be stored is identical to the stored data on a block-by-block basis by comparing signatures of the data requested to be stored and the stored data. For example, if a signature identical to a calculated signature of the data requested to be stored exists in the signature management unit 134, the deduplicator 135 may determine that the data requested to be stored is duplicate data. If the signature identical to the calculated signature does not exist, the deduplicator 135 may determine that the data requested to be stored is not duplicate data.

The storage device 140 may store data requested to be stored and may be implemented as a solid state drive or solid state disk (SSD). However, this is merely an embodiment to which the present inventive concept is applied, and the storage device 140 is not limited to the SSD and can be implemented in various forms. For example, the storage device 140 may be integrated into one semiconductor device and may be implemented as a Personal Computer Memory Card International Association (PCMCIA) card, a compact flash (CF) card, a smart media card (SM, SMC, etc.), a memory stick, a multimedia card (MMC, RS-MMC, MMCmicro, etc.), an SD card (SD, miniSD, microSD, SDHC, etc.), a universal flash storage (UFS), etc.

The storage device 140 may receive or transmit data from or to the control unit 110. The storage device 140 may include a controller 150, a memory 160, and a storage unit 170. The controller 150 may be connected to the memory 160 and the storage unit 170. The controller 150 manages data transmission/reception between the control unit 110 and the storage device 140 and relays data transmission/reception between the storage unit 170 and the control unit 110. That is, the controller 150 may control the storage unit 170 in response to a data input/output request from the control unit 110.

The memory 160 may include a mapping table 161. The mapping table 161 may include LBA-physical block address (PB A) translation information 162 and duplicate information 163. When an LBA received from the control unit 110 is linked to a PBA of the storage unit 170, the LBA-PBA translation information 162 may include information about how the LBA and the PBA correspond to each other. The duplicate information 163 may be received from the deduplicator 135 of the control unit 110. That is, the duplicate information 163 generated by the deduplicator 135 may not be stored in the deduplicator 135 but in the memory 160.

The mapping table 161 may be updated whenever the control unit 110 determines whether data is duplicate data or not. The memory 160 may be, e.g., a dynamic random access memory (DRAM). In another example, the memory 160 may be a static random access memory (SRAM). In FIG. 1, the memory 160 is located outside the controller 150. However, the memory 160 may also be located inside the controller 150, depending on embodiment.

The storage unit 170 may store data provided by the control unit 110. Examples of the storage unit 170 may include a NAND-flash, a NOR-flash, a phase-change random access memory (PRAM), a ferroelectric random access memory (FRAM), a resistive random access memory (RRAM), a magneto-resistive random access memory (MRAM), a hard mask, and an SSD. The storage unit 170 may be any storage unit that includes storage mediums capable of retaining data even when power supply is interrupted.

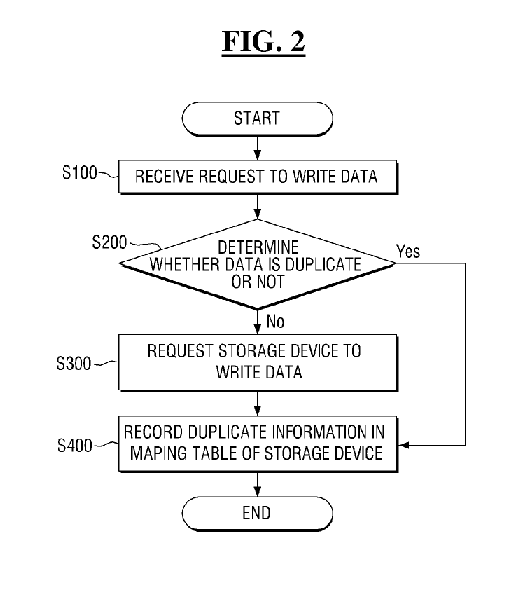

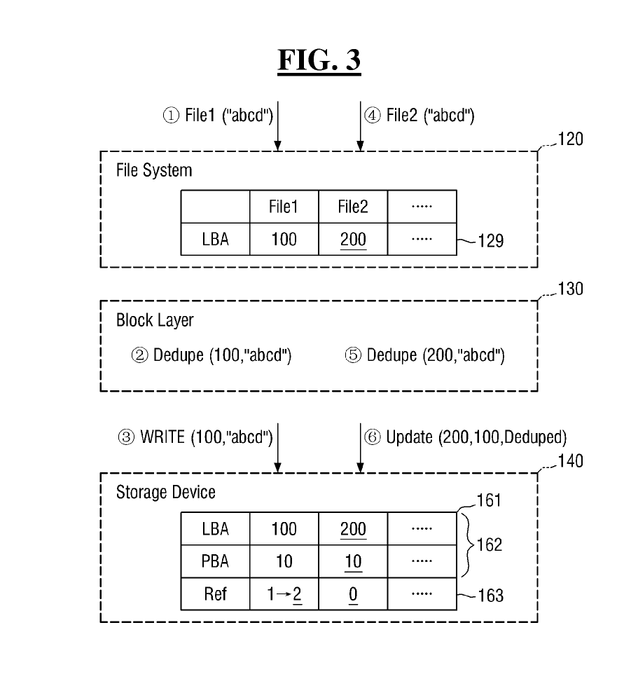

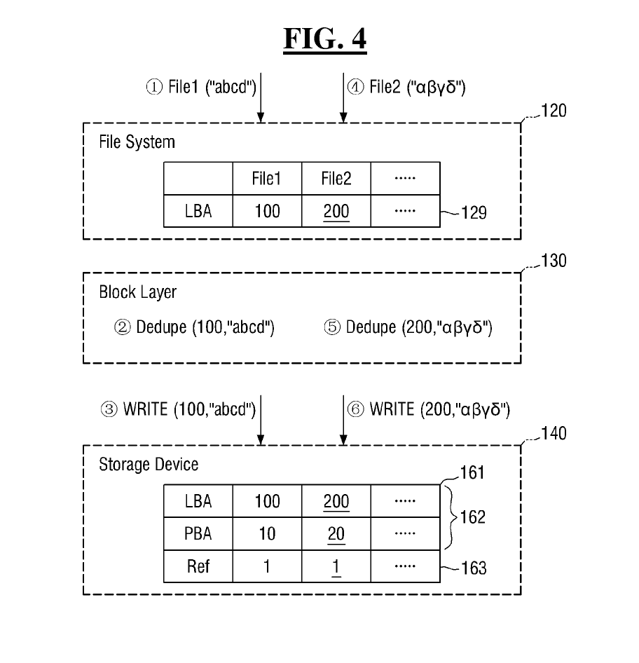

A method of operating the storage system 100 of FIG. 1 will now be described with reference to FIGS. 1 through 4. FIG. 2 is a flowchart illustrating a method of operating the control unit 110 and the storage device 140. FIGS. 3 and 4 are diagrams illustrating the method of operating the control unit 110 and the storage device 140.

Referring to FIGS. 2 and 3, when the control unit 110 receives a request to write a first file File1, that is, first data “abcd” from the client 10 as indicated by \textcircled{1}, the file system 120 links an LBA to the first data “abcd” (operation S100). Then, the file system 120 stores the linked content in an LBA mapping table 129. The LBA mapping table 129 is included in the file system 120 and managed by the file system 120. In FIG. 3, an LBA ‘100’ is linked to the first data “abcd.”

The block layer 130 determines whether the first data “abcd” is duplicate as indicated by \textcircled{2}(operation S200). This determination may be performed by, in particular, the deduplicator 135. As described above with reference to FIG. 1, the first data “abcd” may be chunked into a plurality of first unit blocks, and a first signature may be created for each of the first unit blocks. Then, whether the first data “abcd” is duplicate may be determined using the first signature. When it is determined that the first data “abcd” is duplicate, the duplicate information 163 about the first data “abcd” is generated.

When determining that the first data “abcd” is not duplicate data, the control unit 110 transmits the first data “abcd” to the storage device 140 and requests the storage device 140 to write the first data “abcd” as indicated by \textcircled{3}(operation S300). The storage device 140 records the LBA-PBA translation information 162 and the duplicate information 163 of the first data “abcd” in the mapping table 161 (operation S400). In FIG. 3, a PBA ‘10’ is linked to the first data “abcd.” Therefore, information about the PBA ‘10’ being linked to the LBA ‘100’ and the duplicate information 163 of the first data “abcd” are recorded in the mapping table 161.

The duplicate information 163 may include first through third reference values. The first reference value indicates that data requested to be stored is not duplicate data, the second reference value indicates that the data requested to be stored is duplicate data, and the third reference value indicates that data stored in the storage unit 170 has been cited multiple times. In FIG. 3, since the first data “abcd” is not duplicate data, the first reference value of “1” is recorded in the first data “abcd” of the mapping table 161. After information about the first data “abcd” is recorded in the mapping table 161, the first data “abcd” is stored in a storage unit 170 corresponding to the PBA ‘10.’

When the control unit 110 receives a request to write a second file File2, that is, second data “abcd” from the client 10 as indicated by \textcircled{4}, the file system 120 links an LBA to the second data “abcd” (operation S100). Then, the file system 120 stores the linked content in the LBA mapping table 129. In FIG. 3, an LBA ‘200’ is linked to the second data “abcd.”

The block layer 130 determines whether the second data “abcd” is duplicate as indicated by \textcircled{5}(operation S200). Here, as described above with reference to FIG. 1, the second data “abcd” may be chunked into a plurality of second unit blocks, and a second signature may be created for each of the second unit blocks. Then, whether the second data “abcd” is identical to the first data “abcd” may be determined by comparing the second signature with the first signature. After it is determined whether the second data “abcd” is identical to the first data “abcd,” the duplicate information 163 about the second data “abcd” is generated. Since the first data “abcd” and the second data “abcd” are identical, the second data “abcd” is duplicate data.

When determining that the second data “abcd” is duplicate data, the control unit 110 does not transmit the second data “abcd” to the storage device 140. Therefore, the second data “abcd” is not stored in the storage device 140. Instead, the mapping table 161 is updated as indicated by \textcircled{6}. The LBA-PBA translation information 162 and the duplicate information 163 of the second data “abcd” are recorded in the mapping table 161 (operation S400). Since the second data “abcd” is duplicate data, the second reference value of “0” is recorded in the second data “abcd” of the mapping table 161. In addition, since the second data “abcd” is identical to the first data “abcd” and shares the PBA of the first data “abcd” with the first data “abcd,” the first reference value of “1” of the first data “abcd” is updated to the third reference value of “2.” The third reference value may be increased whenever a request to write data identical to the first data “abcd” is received from the client 10. For example, the control unit 110 may receive a request to store third data, fourth data, etc. from the client 10. In this case, if the third data and the fourth data are identical to the first data, the third reference value may be changed from “2” to “3” and from “3” to “4.”

A case where the second data is not identical to the first data will now be described with reference to FIG. 4. Referring to FIG. 4, when the control unit 110 receives a request to write a first file File1, that is, first data “abed” from the client 10 as indicated by \textcircled{1}, the file system 120 links an LBA to the first data “abcd.” Then, the file system 120 stores the linked content in the LBA mapping table 129. In FIG. 4, an LBA ‘100’ is linked to the first data “abcd.”

The block layer 130 determines whether the first data “abed” is duplicate as indicated by \textcircled{2}. Here, as described above with reference to FIG. 1, the first data “abcd” may be chunked into a plurality of unit blocks, and whether the first data “abcd” is duplicate data may be determined using a signature of each unit block. After it is determined whether the first data “abcd” is duplicate data, the duplicate information 163 about the first data “abcd” is generated.

When determining that the first data “abcd” is not duplicate data, the control unit 110 transmits the first data “abcd” to the storage device 140 and requests the storage device 140 to write the first data “abcd” as indicated by 0. The storage device 140 records the LBA-PBA translation information 162 and the duplicate information 163 of the first data “abcd” in the mapping table 161. In FIG. 4, a PBA ‘10’ is linked to the first data “abcd.” Therefore, information about the PBA ‘10’ being linked to an LBA ‘100’ and the first reference value of “1” are recorded in the mapping table 161. After information about the first data “abcd” is recorded in the mapping table 161, the first data “abcd” is stored in a storage unit 170 corresponding to the PBA ‘10.’

When the control unit 110 receives a request to write a second file File2, that is, second data “αβγδ” from the client 10 as indicated by 0, the file system 120 links an LBA to the second data “αβγδ” Then, the file system 120 stores the linked content in the LBA mapping table 129. In FIG. 4, an LBA ‘200’ is linked to the second data “αβγδ”

The block layer 130 determines whether the second data “αβγδ” is duplicate as indicated by \textcircled{5}. Here, the second data “αβγδ” may be chunked into a plurality of unit blocks, and a signature may be created for each of the unit blocks. Then, whether the second data “αβγδ” is identical to the first data “abed” may be determined by comparing the created signature with the signature of the first data “abcd.”

If the first data “abed” and the second data “αβγδ” are not identical, the second data “αβγδ” is not duplicate data. Therefore, the second data “αβγδ” is not stored in the storage device 140. Accordingly, the mapping table 161 included in the memory 160 is updated. Specifically, the LBA ‘200’ of the second data “αβγδ” and a PBA ‘20’ linked to the LBA ‘200’ are recorded in the mapping table 161. Since the second data “αβγδ” is not duplicate data, the first reference value of “1” is recorded in the mapping table 161 as the duplicate information 163. After information about the second data “αβγδ” is recorded in the mapping table 161, the second data “αβγδ” is recorded in a storage unit 170 corresponding to the PBA ‘20.’

Generally, the block layer 130 may have a duplicate mapping table. In particular, the duplicate mapping table may be stored in and managed by the deduplicator 135. After the deduplicator 135 determines whether data is duplicate data, the determination result is recorded in the duplicate mapping table. To prevent the loss of the duplicate mapping table, the duplicate mapping table is backed up in the storage unit 170. The storage device 140 may have a mapping table for storing LBA-PBA translation information, separately the duplicate mapping table. In this case, since the duplicate mapping table and the mapping table are managed separately, the amount of storage needed may increase compared with the present inventive step. In addition, since an additional operation of backing up the duplicate mapping table in the storage unit 170 should be performed separately from an operation of storing data in the storage unit 170, a lot of time is required for deduplication.

In the present inventive concept, however, the duplicate mapping table is integrated into the mapping table 161 of the storage unit 170 and managed accordingly. In this case, the amount of storage needed for deduplication can be reduced, and the number of operations performed for deduplication can be reduced. Consequently, the storage system 100 can be used more efficiently and at higher speed.

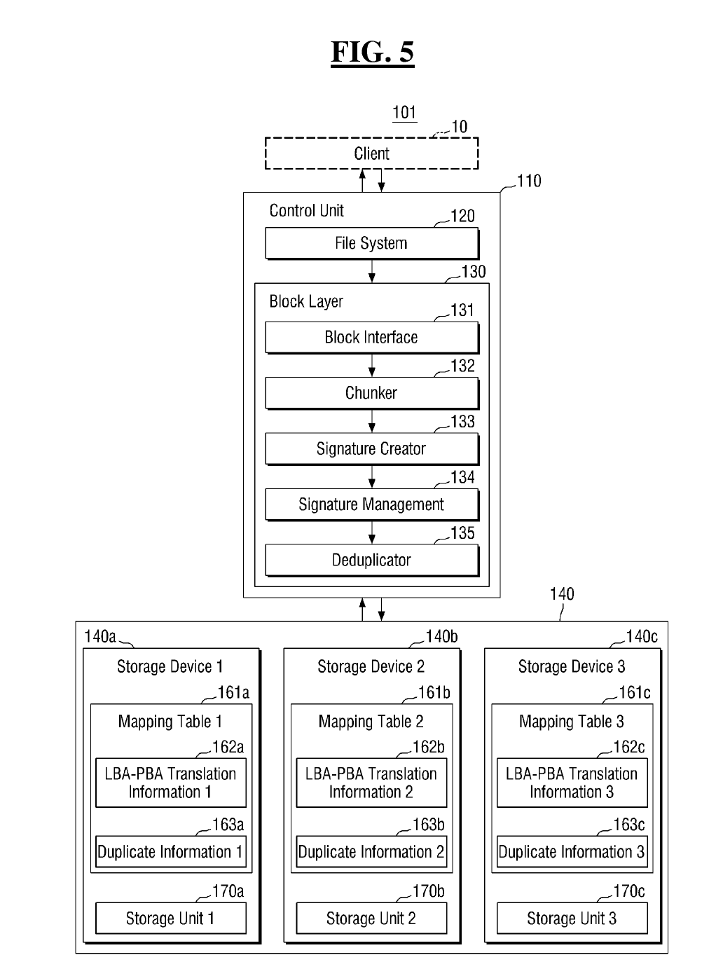

A storage system according to another embodiment of the present inventive concept will now be described with reference to FIG. 5. For simplicity, a description of elements substantially identical to those of the previous embodiment will be omitted, and the current embodiment will hereinafter be described, focusing mainly on differences with the pervious embodiment.

FIG. 5 is a schematic block diagram of a storage system 101 according to another embodiment of the present inventive concept. In FIG. 5, a controller and a memory included in each of a plurality of storage devices 140a through 140c are not illustrated for ease of description. Referring to FIG. 5, the storage system 101 according to the current embodiment of the present inventive concept may include a control unit 110 and a storage structure composed of a plurality of storage devices 140a through 140c. The control unit 110 may include a file system 120 and a block layer 130. The block layer 130 may include a block interface 131, a chunker 132, a signature creator 133, a signature management unit 134, and a deduplicator 135, which will not be described here since a description thereof has been provided above.

The storage structure composed of a plurality of storage devices 140a through 140c may be a storage array having the storage devices 140a through 140c as a single node or a distributed storage structure having the storage devices 140a through 140c as a plurality of nodes connected by a network. In FIG. 5, three storage devices are illustrated. However, the present inventive concept is not limited thereto, and the number of storages devices can be less than or greater than three.

Each of the storage devices 140a through 140c may include one mapping table 161a, 161b or 161c in a memory 160 thereof. Each of the mapping tables 161a through 161c may include LBA-PBA translation information 162a, 162b or 162c and duplicate information 163a, 163b or 163c generated by the deduplicator 135. Each of the mapping tables 161a through 161c may include the LBA-PBA translation information 162a, 162b or 162c for a PBA of the storage device 140a, 140b or 140c that includes the mapping table 161a, 161b or 161c. Specifically, a first mapping table 161a may include first LBA-PBA translation information 162a for a PBA of a first storage unit 170a. A second mapping table 161b may include second LBA-PBA translation information 162b for a PBA of a second storage unit 170b. A third mapping table 161c may include third LBA-PBA translation information 162c for a PBA of a third storage unit 170c. Therefore, the first through third mapping tables 161a through 161c include different information and are not duplicate tables.

Even if a plurality of storage devices 140a through 140c are included, since it is the deduplicator 135 of the control unit 110 that determines whether data is duplicate, deduplication can be performed without any problem.

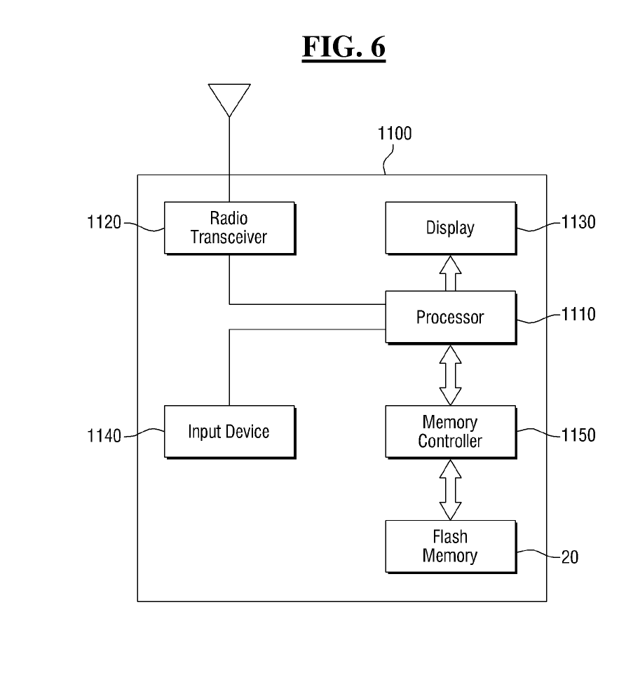

FIG. 6 is a block diagram of an electronic device 1100 including a nonvolatile memory 20 according to an embodiment of the present inventive concept. Referring to FIG. 6, the electronic device 1100 such as a cellular phone, a smartphone or a tablet personal computer (PC) may include the nonvolatile memory 20 which can be implemented as a flash memory and a memory controller 1150 which can control the operation of the nonvolatile memory 20. The nonvolatile memory 20 may be the storage device 140 illustrated in FIG. 1 and/or the storage devices 140a through 140c illustrated in FIG. 5.

The memory controller 1150 is controlled by a processor 1110 that controls the overall operation of the electronic device 1100. The memory controller 1150 may be the control unit 110 illustrated in FIGS. 1 and 5. Data stored in the nonvolatile memory 20 may be displayed on a display 1130 under the control of the memory controller 1150 that operates under the control of the processor 1110.

A radio transceiver 1120 may receive or transmit radio signals through an antenna ANT. For example, the radio transceiver 1120 may convert a radio signal received through the antenna ANT into a signal that can be processed by the processor 1110. Therefore, the processor 1110 may process a signal output from the radio transceiver 1120 and store the processed signal in the nonvolatile memory 20 via the memory controller 1150 or display the processed signal on the display 1130. In addition, the radio transceiver 1120 may convert a signal output from the processor 1110 into a radio signal and transmit the radio signal to an external device through the antenna ANT.

An input device 1140 is a device by which a control signal for controlling the operation of the processor 1110 or data to be processed by the processor 1110 can be input. The input device 1140 may be implemented as a pointing device such as a touchpad or computer mouse, a keypad, or a keyboard. The processor 1110 may control the display 1130 to display data output from the nonvolatile memory 20, a radio signal output from the radio transceiver 1120, or data output from the input device 1140.

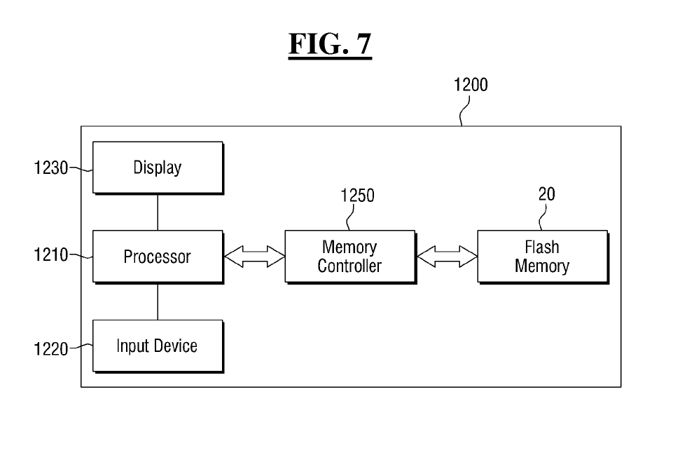

FIG. 7 is a block diagram of an electronic device 1200 including a nonvolatile memory 20 according to another embodiment of the present inventive step.

Referring to FIG. 7, the electronic device 1200 can be implemented as a data processor such as a PC, a tablet computer, a net-book, an e-reader, a personal digital assistant (PDA), a portable multimedia player (PMP), an MP3 player, or an MMP4 player. The electronic device 1200 includes the nonvolatile memory 20 such as a flash memory and a memory controller 1250 which can control the operation of the nonvolatile memory 20. The nonvolatile memory 20 may be the storage device 140 illustrated in FIG. 1 and/or the storage devices 140a through 140c illustrated in FIG. 5. The memory controller 1250 may be the control unit 110 illustrated in FIG. 1 and/or FIG. 5.

The electronic device 1200 may include a processor 1210 for controlling the overall operation of the electronic device 1200. The memory controller 1250 is controlled by the processor 1210. The processor 1210 may display data stored in the nonvolatile memory 20 on a display 1230 in response to an input signal generated by an input device 1220. The input device 1220 may be implemented as a pointing device such as a touchpad or computer mouse, a keypad, or a keyboard.

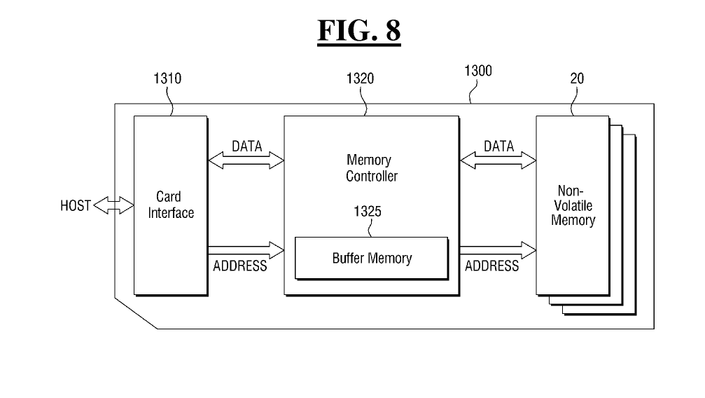

FIG. 8 is a block diagram of an electronic device 1300 including a nonvolatile memory 20 according to another embodiment of the present inventive concept. Referring to FIG. 8, the electronic device 1300 includes a card interface 1310, a memory controller 1320, and the nonvolatile memory 20 such as a flash memory.

The electronic device 1300 may transmit or receive data to or from a host through the card interface 1310. Depending on embodiment, the card interface 1310 may be, but is not limited to, a secure digital (SD) card interface or a multimedia card (MMC) interface. The card interface 1310 may interface data exchange between the host and the memory controller 1320 according to a communication protocol of the host that can communicate with the electronic device 1300.

The memory controller 1320 may control the overall operation of the electronic device 1300 and control data exchange between the card interface 1310 and the nonvolatile memory 20. In addition, a buffer memory 1325 of the memory controller 1320 may buffer data exchanged between the card interface 1310 and the nonvolatile memory 20. The memory controller 1320 is connected to the card interface 1310 and the nonvolatile memory 20 by a data bus DATA and an address bus ADDRESS. Depending on embodiment, the memory controller 1320 receives an address of data to be read or written from the card interface 1310 through the address bus ADDRESS and transmits the address bus ADDRESS to the nonvolatile memory 20.

In addition, the memory controller 1320 receives or transmits data to be read or written through the data bus DATA connected to each of the card interface 1310 and the nonvolatile memory 20. Depending on embodiment, the memory controller 1320 illustrated in FIG. 8 may perform the same or similar function as the control unit 110 illustrated in FIG. 1 and/or FIG. 5. Therefore, the memory controller 1320 may perform deduplication before writing data to the nonvolatile memory 20.

Various data are stored in the nonvolatile memory 20. Depending on embodiment, a read operation and a write operation may be performed simultaneously on the nonvolatile memory 20. Here, a read operation and a write operation may be performed on different memory cell arrays of the nonvolatile memory 20. The nonvolatile memory 20 may be the storage device 140 illustrated in FIG. 1 or the storage devices 140a through 140c illustrated in FIG. 5.

When the electronic device 1300 of FIG. 8 is connected to the host such as a PC, a tablet PC, a digital camera, a digital audio player, a mobile phone, console video game hardware, or a digital set-top box, the host may transmit data to the nonvolatile memory 20 or receive data stored in the nonvolatile memory 20 through the card interface 1310 and the memory controller 1320.

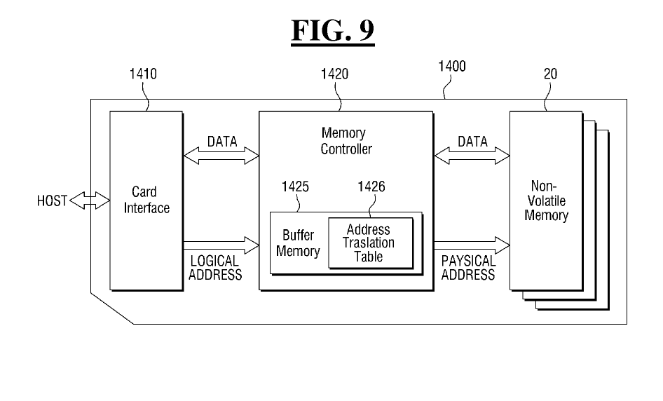

FIG. 9 is a block diagram of an electronic device 1400 including a nonvolatile memory 20 according to another embodiment of the present inventive concept. Referring to FIG. 9, the electronic device 1400 includes a card interface 1410, a memory controller 1420, and the nonvolatile memory 20 such as a flash memory. The electronic device 1400 may perform data communication with a host through the card interface 1410. Depending on embodiment, the card interface 1410 may be, but is not limited to, an SD card interface or an MMC interface. The card interface 1410 may perform data communication between the host and the memory controller 1420 according to a communication protocol of the host that can communicate with the electronic device 1400.

The memory controller 1420 may control the overall operation of the electronic device 1400 and control data exchange between the card interface 1410 and the nonvolatile memory 20. In addition, a buffer memory 1425 included in the memory controller 1420 may store various data to control the overall operation of the electronic device 1400. The memory controller 1420 may be connected to the card interface 1410 and the nonvolatile memory 20 by a data bus DATA and a logical address bus LOGICAL ADDRESS.

Depending on embodiment, the memory controller 1420 may receive an address of read data or write data from the card interface 1410 through the logical address bus LOGICAL ADDRESS and transmit the address of the read data or the write data to the nonvolatile memory 20 through a physical address bus PHYSICAL ADDRESS. The nonvolatile memory 20 may be the storage device 140 illustrated in FIG. 1 and/or the storage devices 140a through 140c illustrated in FIG. 5.

In addition, the memory controller 1420 may receive or transmit read data or write data through the data bus DATA connected to each of the card interface 1410 and the nonvolatile memory 20. The memory controller 1420 may perform the same or similar function as the control unit 110 illustrated in FIG. 1 and/or FIG. 5. Therefore, the memory controller 1420 may perform deduplication before writing data to the nonvolatile memory 20.

Depending on embodiment, the memory controller 1420 of the electronic device 1400 may include an address translation table 1426 in the buffer memory 1425. The address translation table 1426 may include a logical address input from an external source and a logical address needed to access the nonvolatile memory 20. During a write operation, the memory controller 1420 may write new data to an arbitrary physical address and update the address translation table 1426. The memory controller 1420 may select from the address translation table 1426 a physical address at which a read operation can be performed at the same time as a write operation by referring to a physical address of data on which the write operation is being performed.

The memory controller 1420 may perform the write operation and the read operation simultaneously and update the address translation table 1426 according to the write operation and the read operation. Therefore, the operation time of the electronic device 1400 can be reduced.

When the electronic device 1400 of FIG. 9 is connected to the host such as a PC, a tablet PC, a digital camera, a digital audio player, a mobile phone, console video game hardware, or a digital set-top box, the host may transmit data to the nonvolatile memory 20 or receive data stored in the nonvolatile memory 20 through the card interface 1410 and the memory controller 1420.

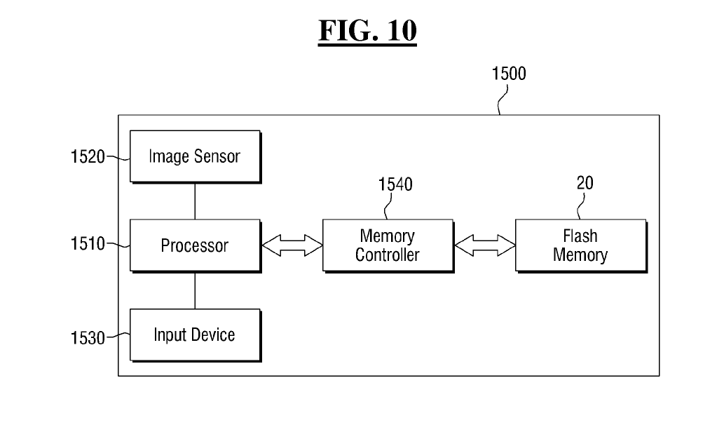

FIG. 10 is a block diagram of an electronic device 1500 including a nonvolatile memory 20 according to another embodiment of the present inventive concept. Referring to FIG. 10, the electronic device 1500 includes the nonvolatile memory 20 such as a flash memory, a memory controller 1540 which controls the data processing operation of the nonvolatile memory 20, and a processor 1510 which can control the overall operation of the electronic device 1500.

Under the control of the processor 1510, the memory controller 1540 determines whether data has first been successfully read from the nonvolatile memory 20. When the data has first been successfully read, a read parameter may be changed. The memory controller 1540 may have the same or similar function as the control unit 110 illustrated in FIG. 1 and/or FIG. 5. Therefore, the memory controller 1540 may perform deduplication when writing data to the nonvolatile memory 20.

An image sensor 1520 of the electronic device 1500 may convert an optical signal into a digital signal and store the digital signal in the nonvolatile memory 20 or display the digital signal on a display 1530 under the control of the processor 1510. In addition, the digital signal stored in the nonvolatile memory 20 is displayed on the display 1530 under the control of the processor 1510. The nonvolatile memory 20 may be the storage device 140 illustrated in FIG. 1 and/or the storage devices 140a through 140c illustrated in FIG. 5.

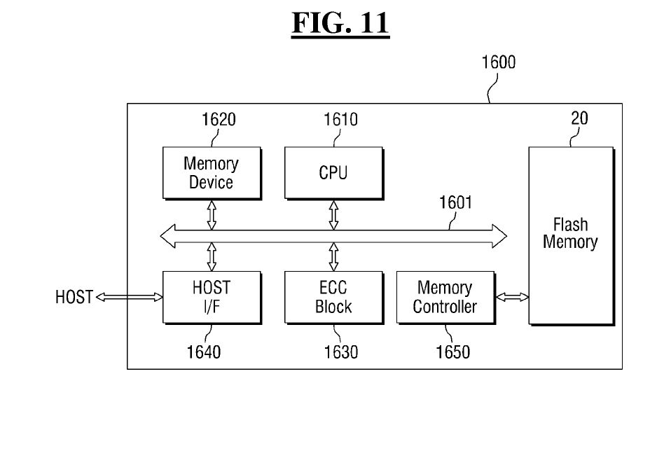

FIG. 11 is a block diagram of an electronic device 1600 including a nonvolatile memory 20 according to another embodiment of the present inventive concept. Referring to FIG. 11, the electronic device 1600 includes the nonvolatile memory 20 such as a flash memory, a memory controller 1650 which controls the operation of the nonvolatile memory 20, and a central processing unit (CPU) 1610 which can control the overall operation of the electronic device 1600. The electronic device 1600 includes a memory 1620 that can be used as an operation memory of the CPU 1610. The memory 1620 may be implemented as a nonvolatile memory such as a read only memory (ROM) or a volatile memory such as a DRAM.

A host connected to the electronic device 1600 may exchange data with the nonvolatile memory 20 through the memory controller 1650 and a host interface 1640. Here, the memory controller 1650 may function as a memory interface, e.g., a flash memory interface. The memory controller 1650 may perform deduplication when writing data to the nonvolatile memory 20.

Depending on embodiment, the electronic device 1600 may further include an error correction code (ECC) block 1630. The ECC block 1630 operating under the control of the CPU 1610 may detect and correct errors included in data read from the nonvolatile memory 20 through the memory controller 1650. The nonvolatile memory 20 may be the storage device 140 illustrated in FIG. 1 and/or the storage devices 140a through 140c illustrated in FIG. 5. The CPU 1610 may control data exchange among the memory controller 1650, the ECC block 1630, a host interface 1640 and the memory 1620 through a bus 1601. The electronic device 1600 may be implemented as a USB memory drive or a memory stick.

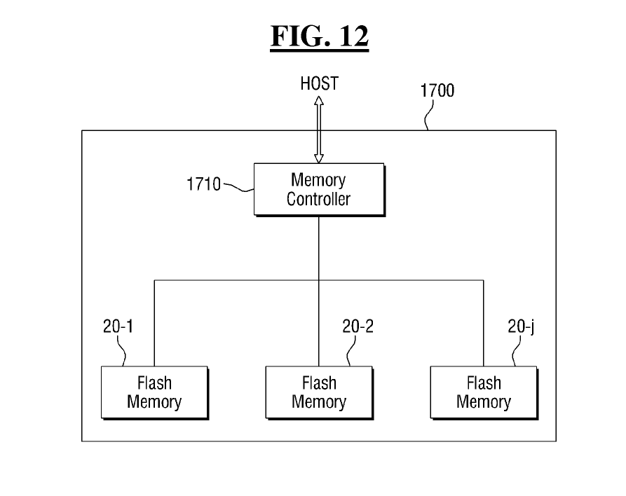

FIG. 12 is a block diagram of an electronic device 1700 including nonvolatile memories 20-1 through 20-j according to another embodiment of the present inventive concept. Referring to FIG. 12, the electronic device 1700 may be implemented as a data storage device such as an SSD. The electronic device 1700 may include a plurality of nonvolatile memories 20-1 through 20-j and a memory controller 1710 capable of controlling the data processing operation of each of the nonvolatile memories 20-1 through 20-j.

The electronic device 1700 may be implemented as a memory system or a memory module. Depending on embodiment, the memory controller 1710 may be implemented inside or outside the electronic device 1700. The memory controller 1710 may perform deduplication when writing data to the nonvolatile memories 20-1 through 20-j. The nonvolatile memories 20-1 through 20-j may be the storage device 140 illustrated in FIG. 1 and/or the storage devices 140a through 140c illustrated in FIG. 5.

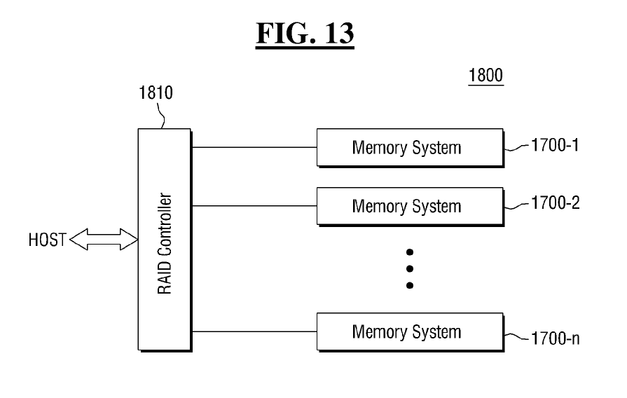

FIG. 13 is a block diagram of a data storage device 1800 including the electronic device 1700 of FIG. 12. Referring to FIGS. 12 and 13, the data storage device 1800 can be implemented as a redundant array of independent disks (RAID) system. The data storage device 1800 may include a RAID controller 1810 and a plurality of memory systems 1700-1 through 1700-n, where n is a natural number.

Each of the memory systems 1700-1 through 1700-n may be the electronic device 1700 illustrated in FIG. 12. The memory systems 1700-1 through 1700-n may form a RAID array. The data storage device 1800 may be implemented as a PC or an SSD. During a program operation, the RAID controller 1810 may transmit program data output from a host to any one of the memory systems 1700-1 through 1700-n according to any one RAID level selected from a plurality of RAID levels based on RAID level information output from the host. In addition, during a read operation, the RAID controller 1810 may transmit data read from any one of the memory systems 1700-1 through 1700-n to the host according to any one RAID level selected based on the RAID level information output from the host.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims. It is therefore desired that the present embodiments be considered in all respects as illustrative and not restrictive, reference being made to the appended claims rather than the foregoing description to indicate the scope of the inventive concept.

What is claimed is:

1. A storage system comprising:
a control unit configured to receive data from a client; and
a storage device configured to store the data;
the control unit comprising a deduplicator configured to determine whether the data is duplicate or not and generate duplicate information based on a determination result; and
the storage device comprising a mapping table including logical block address (LBA)-physical block address (PBA) translation information and the duplicate information.

2. The storage system of claim 1, wherein the storage device comprises a controller, a memory, and a storage unit to store the data, and wherein the memory includes the mapping table.

3. The storage system of claim 1, wherein the control unit further comprises:
a chunker configured to chunk the data into a plurality of unit blocks;
a signature creator configured to create a signature of each of the unit blocks; and
a signature management unit configured to manage the signature of each of the unit blocks;
wherein the deduplicator is configured to determine whether the data is duplicate or not by comparing the signatures.

4. The storage system of claim 3, wherein the signature of each of the unit blocks comprises a hash value of each of the unit blocks.

5. The storage system of claim 1, wherein the mapping table is updated based upon the determination of duplicate data.

6. The storage system of claim 1, wherein the storage device comprises a plurality of storage device units each including a respective mapping table.

7. The storage system of claim 6, wherein each of the mapping tables comprises LBA-PBA translation information for a PBA of a respective storage device that includes the mapping table.

8. A storage system comprising:
a storage device configured to store first data; and
a control unit configured to determine whether second data received from a client is identical to the first data by comparing the second data with the first data, and configured to generate duplicate information based on a determination result;
the storage device comprising a mapping table that includes logical block address (LBA)-physical block address (PBA) translation information of the first data, LBA-PBA translation information of the second data, and the duplicate information.

9. The storage system of claim 8, wherein if the first data and the second data are identical, a PBA of the first data and a PBA of the second data are identical in the mapping table.

10. The storage system of claim 8, wherein the storage device comprises a controller, a memory, and a storage unit, and wherein the memory includes the mapping table.

11. The storage system of claim 10, wherein the second data is stored in the storage unit if the first data and the second data are not identical and is not stored in the storage unit if the first data and the second data are identical.

12. The storage system of claim 8, wherein the control unit is configured to chunk the first data into a plurality of first unit blocks, create a first signature of each of the first unit blocks, chunk the second data into a plurality of second unit blocks, create a second signature of each of the second unit blocks, and determine whether the first data and the second data are identical by comparing the first and second signatures.

13. The storage system of claim 8, wherein the duplicate information comprises first and second reference values, and the control unit is configured to record the first reference value in the first data of the mapping table and, if the second data is identical to the first data, record the second reference value in the second data of the mapping table.

14. The storage system of claim 13, wherein if the second data is identical to the first data, the first reference value recorded in the first data of the mapping table is changed to a third reference value.

15. The storage system of claim 13, wherein if the second data is not identical to the first data, the first reference value is recorded in the second data of the mapping table.

16. A method of controlling a storage system including a control unit configured to receive data from a client, and a storage device configured to store the data, the method comprising:
providing the control unit with a deduplicator configured to determine whether the data is duplicate or not and generate duplicate information based on a determination result; and
storing a mapping table in the storage device and including logical block address (LBA)-physical block address (PBA) translation information and the duplicate information.

17. The method of claim 16, wherein the storage device comprises a controller, a memory, and a storage unit to store the data, and wherein the memory includes the mapping table.

18. The method of claim 16, further comprising:
chunking the data into a plurality of unit blocks;
creating a signature of each of the unit blocks; and
managing the signature of each of the unit blocks;
wherein the deduplicator is configured to determine whether the data is duplicate or not by comparing the signatures.

19. The method of claim 18, wherein the signature of each of the unit blocks comprises a hash value of each of the unit blocks.

20. The method of claim 16, wherein the mapping table is updated based upon the determination of duplicate data.
